(19) United States
(12) Patent Application Publication
(10) Pub. No.: US 2016/0019476 A1
(43) Pub. Date: Jan. 21, 2016

(54) Aggregate Reporting

(71) Applicant: Benjamin Garner, Hood River, OR (US)

(72) Inventor: Benjamin Garner, Hood River, OR (US)

(21) Appl. No.: 14/334,224

(22) Filed: Jul. 17, 2014

(51) Int. Cl. G06Q 10/06

(52) U.S. Cl. CPC G06Q 10/063

(57) ABSTRACT

The instant application discloses, among other things, techniques to allow flexibility in determining which data should be included in an aggregated summary, and which should be presented on its own.

### FIELD

This disclosure relates to Aggregate Reporting.

### BACKGROUND

There are many applications available to allow managers at various levels of an enterprise to view aggregate data applicable to offices, regions, countries, or other groupings relevant to appropriate scopes of command. The data from an office within a region will generally be aggregated with other offices within that region.

### SUMMARY

The instant application discloses, among other things, techniques to allow additional flexibility in determining which data should be included in an aggregate, and which should be presented on its own.

### BRIEF DESCRIPTION OF THE DRAWINGS

FIG. 1 is an example of a system on which Aggregate Reporting may be implemented according to one embodiment.

FIG. 2 is an example of an aggregate with various metrics aggregated, using conventional techniques.

FIG. 3 is an example of Aggregate Reporting with various metrics aggregated, according to one embodiment.

FIG. 4 is an example of Aggregate Reporting budget aggregate, according to one embodiment.

FIG. 5 is an example of Aggregate Reporting budget aggregate, according to another embodiment.

FIG. 6 is an example of Aggregate Reporting budget aggregate, according to another embodiment.

FIG. 7 is an example of Aggregate Reporting budget aggregate, according to another embodiment.

FIG. 8 is an example of Aggregate Reporting budget aggregate, according to another embodiment.

FIG. 9 illustrates a component diagram of a computing device according to one embodiment.

### DETAILED DESCRIPTION

A more particular description of certain embodiments of Aggregate Reporting may be had by references to the embodiments shown in the drawings that form a part of this specification, in which like numerals represent like objects.

The instant application discloses, among other things, techniques to allow Aggregate Reporting, which may allow a manager additional flexibility in determining which data should be included in an aggregate, or roll up, and which should be presented on its own.

Data of interest may include, for example, revenue, income, sales, costs, salary, staff size, or other data of interest. For example, a CEO or CFO of a multinational company may wish to view data at an individual outlet level, such as a store, a country level, such as Canada, a regional level, such as Western Europe, or a global level, including all of the company's assets. When viewing at the country level, for example, all assets in each country may be aggregated and an aggregate number may be shown for the entire country. However, it may make sense in certain situations to exclude some stores or present them on their own separately.
For example, if there are products not sold in a country, it may be desirable to exclude that country from aggregation if the numbers are reported on a per capita basis. Including the country in such a case may skew the results and inaccurately mask real market saturation. One having skill in the art will recognize there may be many metrics that may be appropriate to exclude from an aggregation.

In another embodiment, a fixed number may be added to an aggregate value.

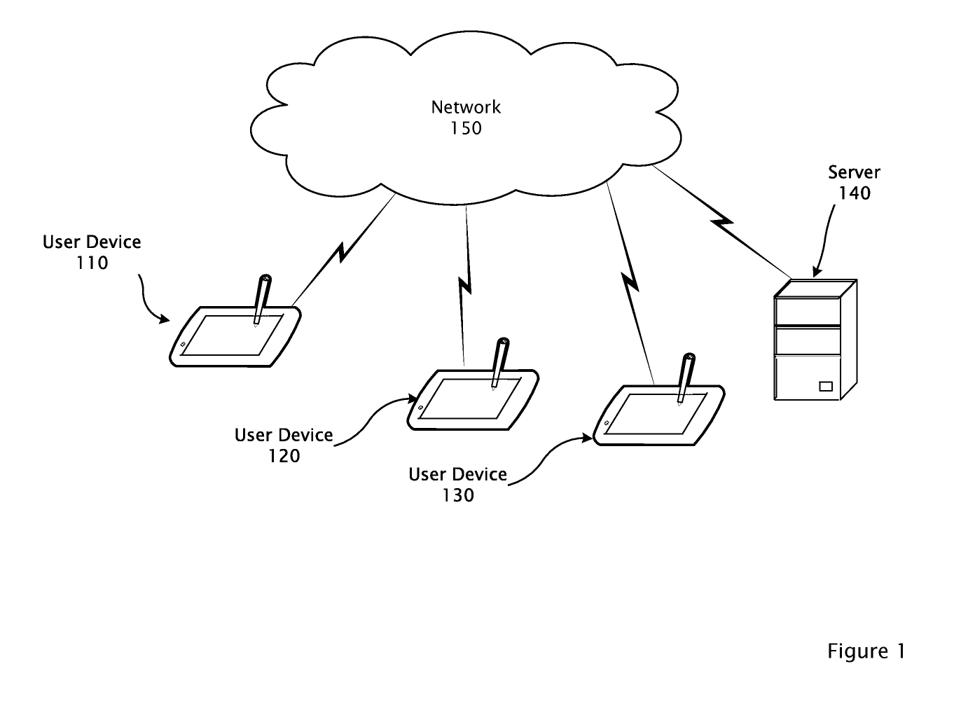

FIG. 1 is an example of a system on which Aggregate Reporting may be implemented. A user may use Aggregate Reporting on User Device 110, 120. User Device 110, 120 may, for example, be a portable device, a desktop computer, or any other type of device capable of processing information, storing files, data or information. Server 140 may contain software applications to process information related to various sites from which to aggregate data, and sites to not include in aggregate data. User Device 130 may access Server 140 to obtain aggregated and non-aggregated data.

Network 150 may include Wi-Fi, cellular data access methods, such as 3G or 4GLTE, the internet, local area networks, wide area networks, or any combination of these or other means of providing data transfer capabilities.

Server 140 may include one or more computers, and may serve several roles, including, but not limited to, storing content, generating reports, or interfacing with test harnesses.

One skilled in the art will recognize that User Device 110, 120, 130 and Server 140 may be of different designs and capabilities.

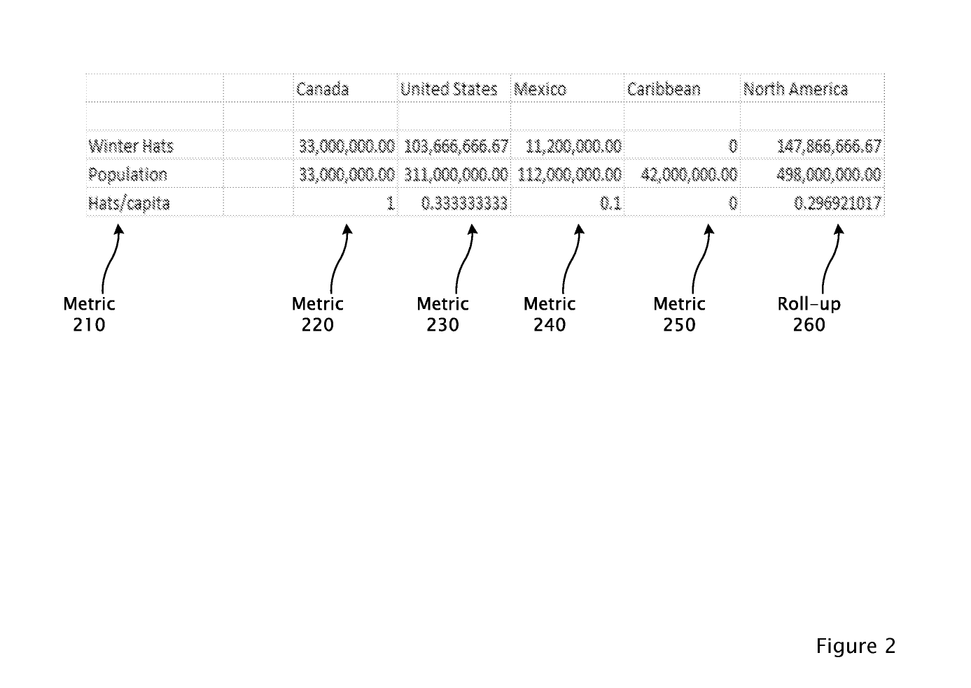

FIG. 2 is an example of an aggregate with various metrics aggregated using conventional techniques. Metric 210 may indicate various measures senior management may want to use to compare various regions. Sales of Winter Hats, population of an area, and a calculated sales of hats per capita may be used. Metric 220 indicates that everyone in Canada bought a winter hat, giving 1 hat per capita. For the US, Metric 230 indicates that one third bought a hat. In Mexico, Metric 240 shows roughly one in ten bought one, while winter hats may not be sold in the Caribbean area. When these metrics are aggregated to North America, Roll-up 260 indicates that overall, 0.2969 hats were sold per capita. This may be misleading because of hats not being sold in the Caribbean area.

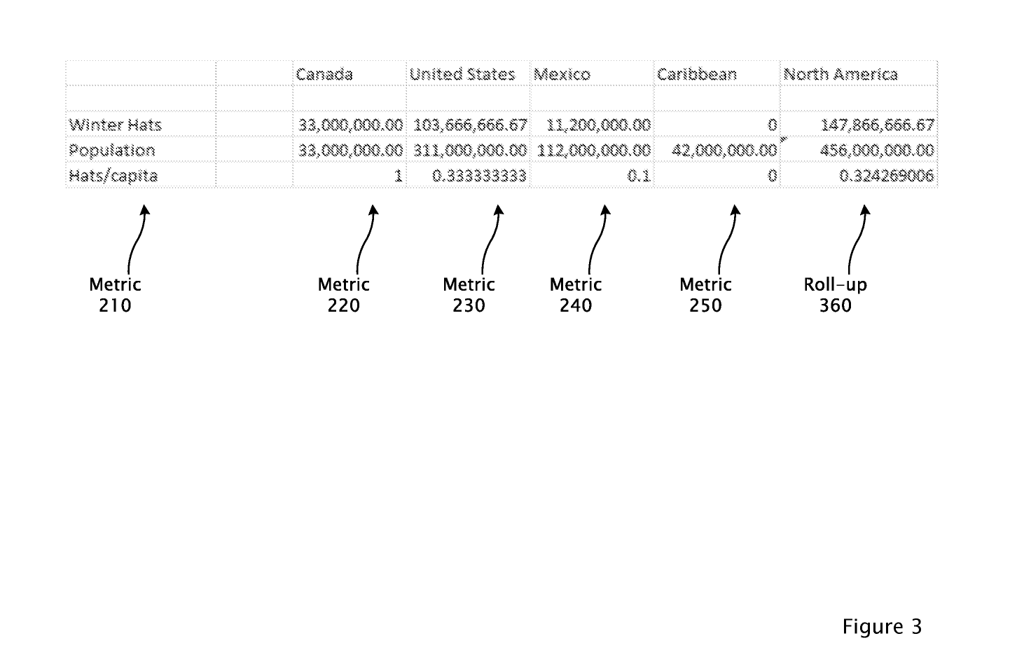

FIG. 3 is an example of Aggregate Reporting with various metrics aggregated, according to one embodiment. In this embodiment, the metrics are the same as in FIG. 2, but the aggregate now excludes the Caribbean, where no winter hats are offered for sale. The resulting aggregated metric of Hats/capita now shows 0.3243, a 9% increase over the conventional way. This may reflect a more accurate picture of the metric if a goal focuses on potential sales.

This example may be implemented by allowing a manager at the North American level to opt-out of including the Caribbean in the aggregated metric. In this event, the system may aggregate other regions but not include Caribbean numbers in the aggregate.

The manager may also simply enter the values to display for North America, effectively making North America a leaf node. In this example, the manager may have added up the Canadian, US, and Mexican numbers, but the manager could have simply entered whatever number was appropriate for desired purposes.

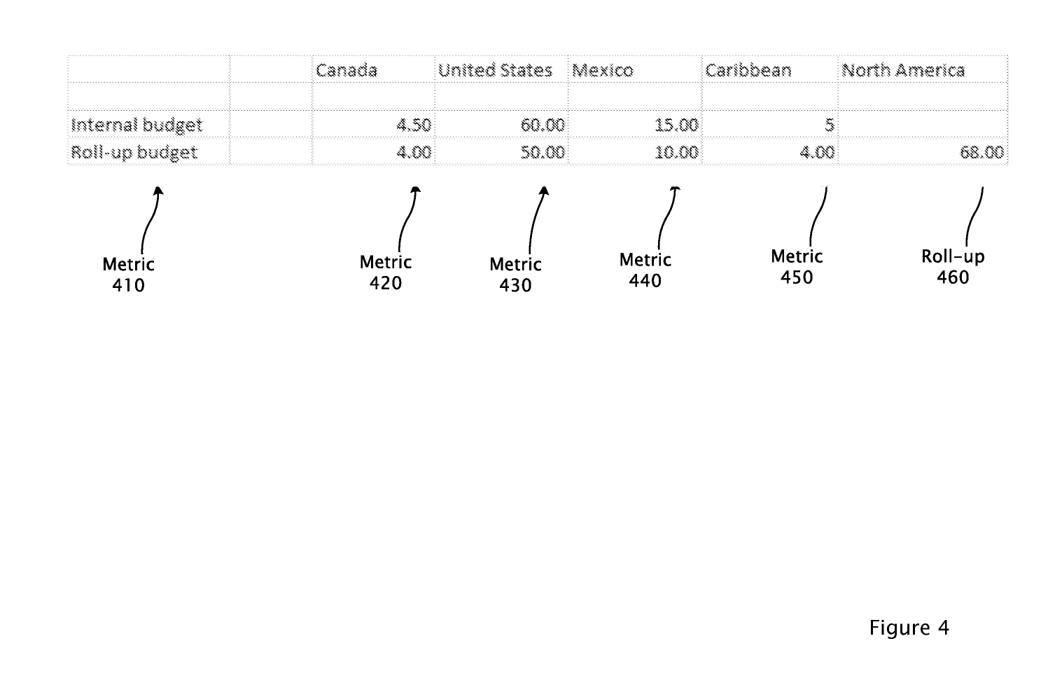

FIG. 4 is an example of Aggregate Reporting budget aggregate, according to one embodiment. Metric 410 may be target budgets for various areas. Metrics 420, 430, 440, 450 may be internal targets and aggregate targets for Canada, United States, Mexico, and Caribbean areas, respectively, while Roll-up 460 may be an aggregate target for North America. Aggregate Reporting may allow the internal budget to reflect internal goals for each area, while aggregating a different amount. A manager may simply enter the values desired for each purpose, internal or aggregate.

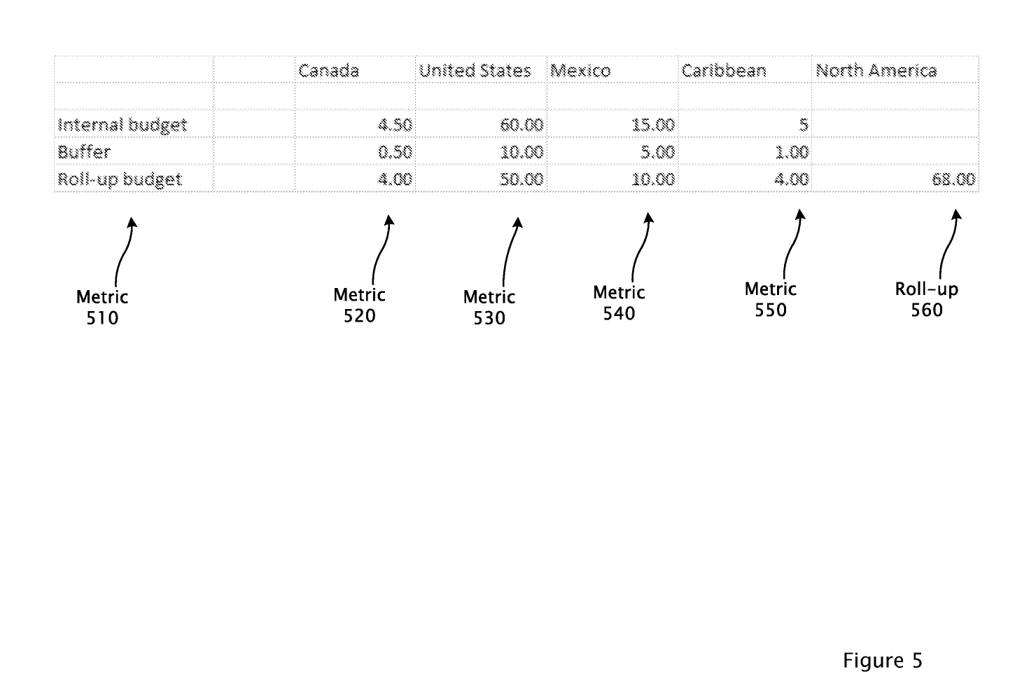

FIG. 5 is an example of Aggregate Reporting budget aggregation, according to another embodiment. Metric 510 may be target budgets for various areas. Metrics 520, 530, 540, 550 may be internal targets and aggregate targets for Canada, United States, Mexico, and Caribbean areas, respectively, while Roll-up 560 may be an aggregate target for North America. Aggregate Reporting may allow the internal budget to reflect internal goals for each area, while aggregating a different amount. In this example, each area may enter a buffer, reflecting an amount by which to reduce their contribution to the aggregate. Changing an internal budget amount will change the amount used for a corresponding aggregate budget. For example, if Canada reduced internal budget from 4.5 to 4.0, the aggregate budget would be reduced automatically from 4.0 to 3.5.

One having skill in the art will recognize that a buffer may also increase or decrease a number, may reflect a percentage or an absolute value, or may be calculated by a formula.

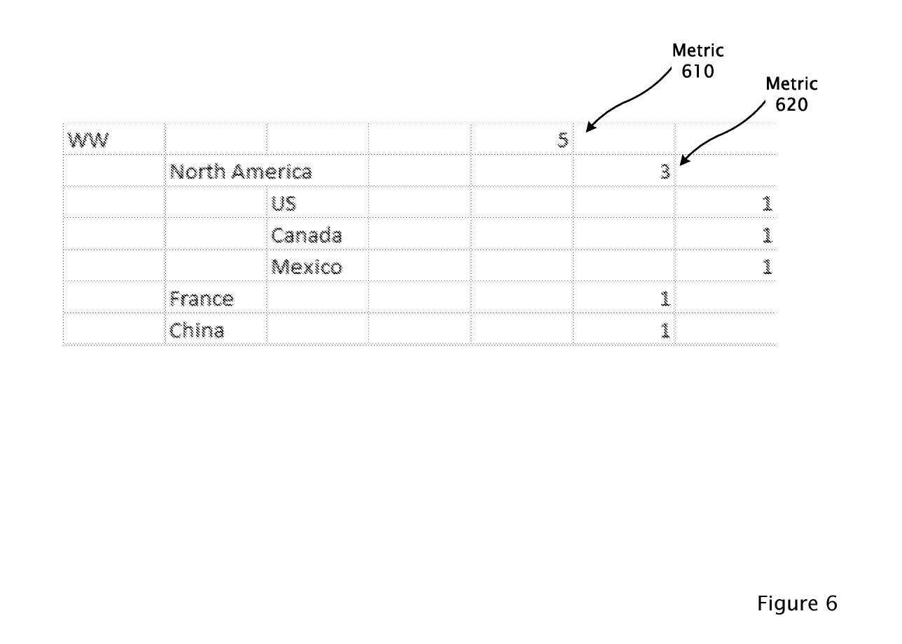

FIG. 6 is an example of Aggregate Reporting budget aggregation, according to another embodiment In this example, the aggregation is performed in a conventional way, with US, Canada, and Mexico each having a metric value of one, aggregating to Metric 620 for North America totaling 3. With France and China each having a value of one, this gives a Metric 610 world-wide (WW) total of 5.

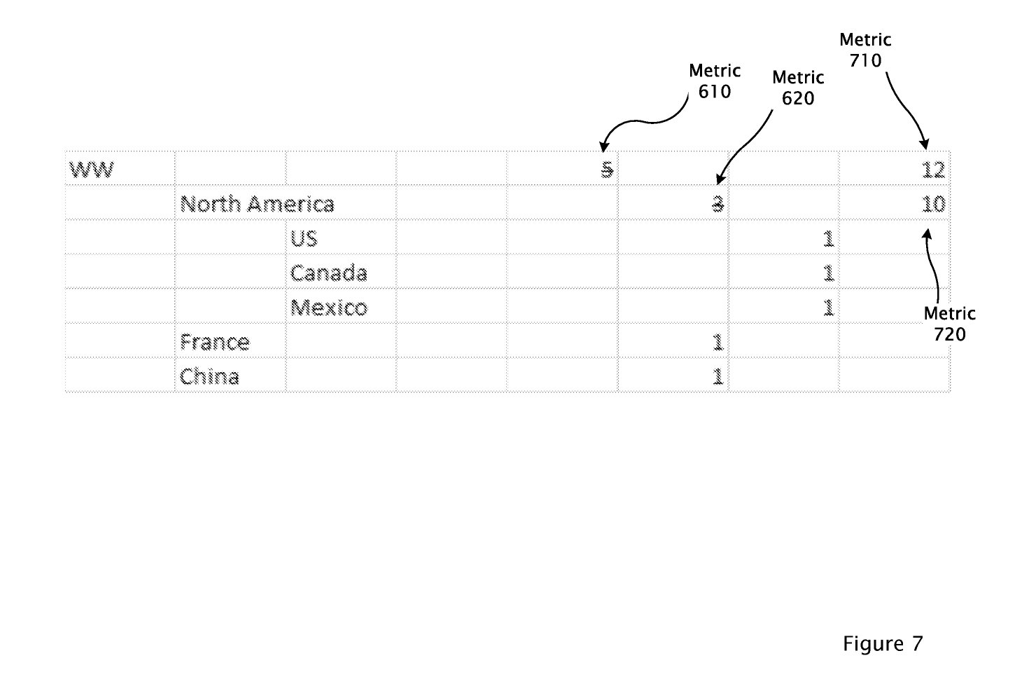

FIG. 7 is an example of Aggregate Reporting budget aggregation, according to another embodiment. In this example, a user has updated Metric 610 for North American value from 3 to Metric 710's value of 10, although the US, Canada, and Mexico units each have a value of one. Metric 620's WW value of 5 has consequently been updated to Metric 710's value of 12, including 10 for North America and one each for France and China.

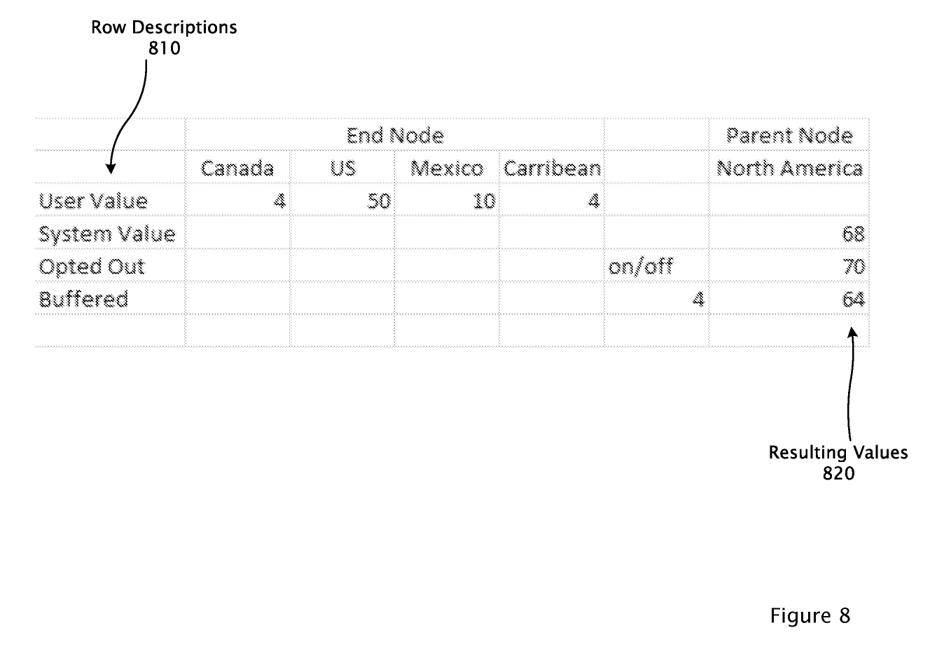

FIG. 8 is an example of Aggregate Reporting budget aggregation, according to another embodiment. In this example, User Values for various units are 4 for Canada, 50 for the US, 10 for Mexico, and 4 for the Caribbean. A parent node for these, North America, has a default system value of 68, the sum of all of the units' user values. If a user chooses to Opt-Out by selecting Opted Out as on, the user may enter a value of 70 for North America. This makes North America effectively a leaf node for the next level of aggregation.

A user may also choose to buffer a value. A buffer may be positive or negative. In this example the buffer is negative; the buffer of 4 is subtracted from the value of 68, resulting in a value to aggregate of 64.

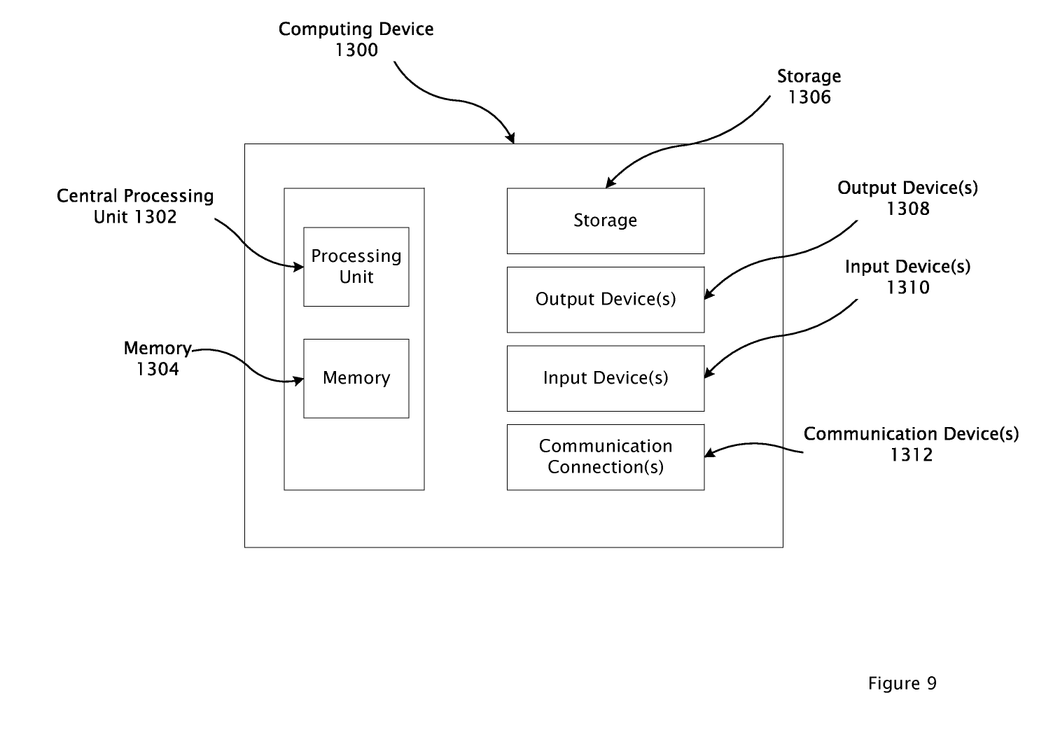

FIG. 9 illustrates a component diagram of a computing device according to one embodiment. The Computing Device (1300) can be utilized to implement one or more computing devices, computer processes, or software modules described herein, including, for example, but not limited to User Device 110 or Server 130. In one example, the Computing Device (1300) can be utilized to process calculations, execute instructions, receive and transmit digital signals. In another example, the Computing Device (1300) can be utilized to process calculations, execute instructions, receive and transmit digital signals, receive and transmit search queries, and hypertext, compile computer code as required by a User Device 110 or Server 130. The Computing Device (1300) can be any general or special purpose computer now known or to become known capable of performing the steps and/or performing the functions described herein, either in software, hardware, firmware, or a combination thereof.

In its most basic configuration, Computing Device (1300) typically includes at least one Central Processing Unit (CPU) (1302) and Memory (1304). Depending on the exact configuration and type of Computing Device (1300), Memory (1304) may be volatile (such as RAM), non-volatile (such as ROM, flash memory, etc.) or some combination of the two. Additionally, Computing Device (1300) may also have additional features/functionality. For example, Computing Device (1300) may include multiple CPU's. The described methods may be executed in any manner by any processing unit in computing device (1300). For example, the described process may be executed by both multiple CPU's in parallel.

Computing Device (1300) may also include additional storage (removable and/or non-removable) including, but not limited to, magnetic or optical disks or tape. Such additional storage is illustrated in FIG. 5 by Storage (1306). Computer readable storage media includes volatile and nonvolatile, removable and non-removable media implemented in any method or technology for storage of information such as computer readable instructions, data structures, program modules or other data. Memory (1304) and Storage (1306) are all examples of computer storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can store the desired information and which can accessed by computing device (1300). Any such computer readable storage media may be part of computing device (1300). Computer readable storage media does not include transient signals.

Computing Device (1300) may also contain Communications Device(s) (1312) that allow the device to communicate with other devices. Communications Device(s) (1312) is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer storage media and communication media. The described methods may be encoded in any computer-readable media in any form, such as data, computer-executable instructions, and the like.

Computing Device (1300) may also have Input Device(s) (1310) such as keyboard, mouse, pen, voice input device, touch input device, etc. Output Device(s) (1308) such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. A computer operable method of aggregating metrics, comprising:
receiving a first value, the first value representing an actual value of a first metric;
receiving a second value, the second value representing a value other than an actual value of a second metric, but used as the second metric for aggregation;
calculating an aggregation of the first value and the second value, giving an aggregate value; and
outputting the aggregated value.

2. The method of claim 1, wherein the second value represents a user-entered value.

3. The method of claim 2, further comprising determining, based upon input from a user, to opt out of including the first value or the second value in the calculation of the aggregate value.

4. The method of claim 3, wherein the second value is an actual value of a metric to which a buffer value has been added.

5. The method of claim 4, wherein the buffer value is a fixed number.

6. The method of claim 4, wherein the buffer value is a percentage of the second value.

7. A system, comprising:
a processor;
a memory operably coupled to the processor; and
components disposed in the memory, the components being operable by the processor, comprising:
a metric value receiving component, configured to receive values representing metrics;
a metric value adjusting component, configured to allow at least one of the received values to be modified, giving a modified value;
an aggregating component, configured to aggregate at least one of the received values and at least one modified value.

8. The system of claim 7, wherein the metric value adjusting component comprises a buffering component, configured to automatically adjust a received value by a fixed amount.

9. The system of claim 7, wherein the metric value adjusting component comprises a buffering component, configured to automatically adjust a received value by a percentage.

10. The system of claim 7, wherein the metric value adjusting component comprises a manual edit component, configured to allow a user to replace the received value with a new value.

11. A computer readable storage media, containing instructions thereon which, when executed by a processor, perform a method comprising:
receiving a first plurality of values, the first values representing metrics obtained from a first branch of a hierarchical organization;
calculating an aggregate value for a first parent node of the first values, giving a first aggregate value;
receiving a second plurality of values, the second values representing metrics obtained from a second branch of a hierarchical organization;
calculating an aggregate value for a second parent node of the second values, giving a second aggregate value;
determining, based upon input received from a user, to replace the first aggregate value with another value, giving a third value;
aggregating the third value and the second aggregate value, giving an fourth aggregate value; and
outputting the fourth aggregated value.

12. The method of claim 11, wherein the third value is entered by a user.
